(19) United States
(12) Patent Application Publication
(10) Pub. No.: US 2014/0190814 A1
(43) Pub. Date: Jul. 10, 2014

(54) TOUCH INPUT DEVICE WITH BUTTON FUNCTION

(71) Applicant: PRIMAX ELECTRONICS LTD., Taipei (TW)

(72) Inventor: Chun-Che Wu, Taipei (TW)

(73) Assignee: PRIMAX ELECTRONICS LTD., Taipei (TW)

(21) Appl. No.: 13/837,537

(22) Filed: Mar. 15, 2013

(30) Foreign Application Priority Data
Jan. 4, 2013 (CN) 201320003460.0

(51) Int. Cl. G06F 1/16

(52) U.S. Cl. CPC G06F 1/16
USPC 200/600

(57) ABSTRACT

A touch input device with a button function is provided. The touch input device includes a base plate, a touch module, an elastic element, and a triggering element. When the touch module is depressed, the triggering element is triggered to generate a touch signal. The triggering element is arranged between the base plate and the touch module. The elastic element is disposed around the peripheral area of the base plate. Since the elastic element is contacted with the peripheral area of the touch module, the elastic force provided to each position of the touch module is substantial equal. Consequently, the tactile feel on each position of the touch module is nearly identical for the user.

### FIELD OF THE INVENTION

The present invention relates to a touch input device, and more particularly to a touch input device with a button function.

### BACKGROUND OF THE INVENTION

The applications of touch input devices are very extensive. In the early stage, a touch input device is installed on a notebook computer. By operating the touch input device, the movement of a cursor may be controlled or a corresponding icon of a user interface may be clicked without the need of using a mouse to operate the notebook computer. With the advance of science and technology, a physical button may be integrated into the touch input device, so that the touch input device has the button function. Under this circumstance, it is not necessary to install plural physical buttons around the peripheral area of the touch input device. The touch input device with the button function may be applied to a notebook computer or a remote controller of an electronic device.

Hereinafter, the structure of a conventional touch input device with a button function will be illustrated with reference to FIGS. 1 and 2. FIG. 1 is a schematic exploded view illustrating a conventional touch input device with a button function. FIG. 2 is a schematic perspective view illustrating the outward appearance of the touch input device of FIG. 1. The touch input device 1 comprises a touch plate 10, an insulation plate 11, a sensing circuit plate 12, a base plate 13, a triggering switch 14, and plural elastic elements 15. The touch plate 10, the insulation plate 11, the sensing circuit plate 12, the plural elastic elements 15, the triggering switch 14 and the base plate 13 are sequentially arranged from top to bottom.

The base plate 13 is used for supporting the touch plate 10, the insulation plate 11, the sensing circuit plate 12, the plural elastic elements 15 and the triggering switch 14. The base plate 13 has plural protrusion posts 131. The plural protrusion posts 131 are located at four corners of the base plate 13, respectively. In addition, the plural protrusion posts 131 are aligned with the plural elastic elements 15, respectively. The plural protrusion posts 131 are respectively sheathed by the plural elastic elements 15, so that the plural elastic elements 15 are fixed by the plural protrusion posts 131. For example, the plural protrusion posts 131 are spiral springs. The triggering switch 14 is disposed on the base plate 13, and located at a middle region of the base plate 13. When the triggering switch 14 is triggered, the triggering switch 14 generates a button signal.

The touch plate 10 has plural coupling posts 101. The plural coupling posts 101 are located at four corners of the touch plate 10, and aligned with the plural elastic elements 15, respectively. The plural coupling posts 101 are penetrated through the corresponding elastic elements 15. Consequently, the elastic elements 15 are connected with the touch plate 10 through the plural coupling posts 101. The insulation plate 11 is arranged between the touch plate 10 and the sensing circuit plate 12 for isolating the touch plate 10 and the sensing circuit plate 12 in order to prevent electrical connection between the touch plate 10 and the sensing circuit plate 12. The sensing circuit plate 12 is used for detecting the touched position of the touch plate 10. The internal structure and the operating principle of the sensing circuit plate 12 are well known to those skilled in the art, and are not redundantly described herein. After the above components are assembled, the resulting structure of the touch input device 1 is shown in FIG. 2.

The operations of the touch input device 1 with the button function will be illustrated in more details as follows. Please refer to FIGS. 1 and 2 again. When the touch plate 10 is touched by the user and the user's finger is moved on the touch plate 10, the movement of the cursor of the notebook computer or the electronic device is correspondingly controlled. When a first position P1 of the touch plate 10 (at a corner of the touch plate 10) is depressed by the user, the touch plate 10 is moved downwardly relative to the base plate 13. Consequently, the plural elastic elements 15 are compressed by the touch plate 10 to accumulate elastic forces. Meanwhile, the depressed first position P1 is detected by the sensing circuit plate 12. In addition, as the touch plate 10 is moved downwardly, the triggering switch 14 is triggered. Consequently, a button signal corresponding to the first position P1 is outputted from the triggering switch 14 to the notebook computer or the electronic device. When the touch plate 10 is no longer depressed by the user, the elastic forces are released. Under this circumstance, the touch plate 10 is moved upwardly relative to the base plate 13 and returned to the position where the touch plate 10 is not depressed. In addition, the triggering switch 14 is no longer triggered.

Similarly, when a second position P2 of the touch plate 10 (at an edge of the touch plate 10) is depressed by the user, the touch plate 10 is moved downwardly relative to the base plate 13. Consequently, the plural elastic elements 15 are compressed by the touch plate 10 to accumulate elastic forces. Meanwhile, the depressed second position P2 is detected by the sensing circuit plate 12. In addition, as the touch plate 10 is moved downwardly, the triggering switch 14 is triggered. Consequently, a button signal corresponding to the second position P2 is outputted from the triggering switch 14 to the notebook computer or the electronic device. When the touch plate 10 is no longer depressed by the user, the elastic forces are released. Under this circumstance, the touch plate 10 is moved upwardly relative to the base plate 13 and returned to the position where the touch plate 10 is not depressed. In addition, the triggering switch 14 is no longer triggered.

However, since the distance between the first position P1 and the corresponding elastic element 15 is shorter than the distance between the second position P2 and the corresponding elastic element 15, the depressing force exerted on the first position P1 is smaller than the depressing force exerted on the second position P2. Since the depressing forces exerted on different positions of the touch plate 10 are different, the tactile feel on the touch plate 10 is usually unsatisfied. Under this circumstance, the user may readily feel tired or uncomfortable because of wrist fatigue.

### SUMMARY OF THE INVENTION

The present invention provides a touch input device with a button function in order to provide an enhanced tactile feel.

In accordance with an aspect of the present invention, there is provided a touch input device with a button function. The touch input device includes a base plate, a touch module, an elastic element, and a triggering switch. The touch module is disposed over the base plate. When the touch module is touched and a touched position is detected by the touch module, the touch module generates a touch signal. The elastic element is disposed over the base plate and under the touch module for providing an elastic force to the touch module. The elastic element is disposed around a peripheral area of the base pate. The triggering switch is disposed on the touch module. When the touch module is depressed, the triggering switch is triggered to generate a button signal corresponding to the touched position.

In an embodiment, the elastic element is a spiral spring, which is made of a metallic material. Moreover, a shape of a wound structure of the elastic element matches a shape of the peripheral area of the base pate.

In an embodiment, the touch module includes a touch sensitive plate and a protective cover. The touch sensitive plate is used for detecting the touched position, thereby generating the touch signal. The protective cover is used for covering the touch sensitive plate and contacting with the base plate and the elastic element, thereby protecting the touch sensitive plate.

In an embodiment, the protective cover includes at least one hooking structure and a fixing recess. The at least one hooking structure is formed on at least one lateral wall of the protective cover. When the at least one hooking structure is engaged with the base plate, the protective cover is fixed on the base plate. The fixing recess is formed in the at least one lateral wall of the protective cover and disposed over the peripheral area of the base plate. When the elastic element is inserted into the fixing recess, the elastic element is fixed in the fixing recess.

In an embodiment, the base plate includes at least one perforation, which is aligned with the at least one hooking structure and formed in at least one lateral wall of the base plate. When the at least one hooking structure is inserted into the at least one perforation, the at least one hooking structure is engaged with the at least one perforation.

In an embodiment, the at least one lateral wall of the base plate is protruded from the peripheral area of the base pate and integrally formed with the base plate. Moreover, the base pate is made of a plastic material.

In an embodiment, the at least one hooking structure and the fixing recess are integrally formed with the protective cover, and the protective cover is made of a plastic material. Moreover, a shape of the fixing recess matches a shape of a wound structure of the elastic element.

In an embodiment, the base plate further includes a contact post, and the contact post is located at a middle region of the base plate. The triggering switch is disposed on a bottom surface of the touch sensitive plate and disposed over the contact post.

In an embodiment, when the protective cover is depressed and moved downwardly relative to the base plate, the elastic element is compressed by the protective cover to accumulate the elastic force, the touched position is detected by the touch sensitive plate and the touch sensitive plate is moved downwardly relative to the base plate, so that the contact post is contacted with the triggering switch to trigger the triggering switch. When the triggering switch is triggered, the button signal corresponding to the touched position is generated by the triggering switch. When the protective cover is not depressed, the elastic force of the elastic element is released, so that protective cover and the touch sensitive plate are moved upwardly relative to the base plate and the triggering switch is not contacted with the contact post.

In an embodiment, the touch sensitive plate is a capacitive touch sensitive plate.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional touch input device with a button function;

FIG. 2 is a schematic perspective view illustrating the outward appearance of the touch input device of FIG. 1;

FIG. 3 is a schematic exploded view illustrating a touch input device with a button function according to an embodiment of the present invention;

FIG. 4 is a schematic exploded view illustrating the touch input device of FIG. 3 and taken along another viewpoint;

FIG. 5 is a schematic perspective view illustrating the outward appearance of the touch input device of FIG. 3;

FIG. 6 is a schematic cutaway view illustrating the touch input device of FIG. 5; and

FIG. 7 is a schematic cutaway view illustrating a portion of the touch input device of FIG. 5.

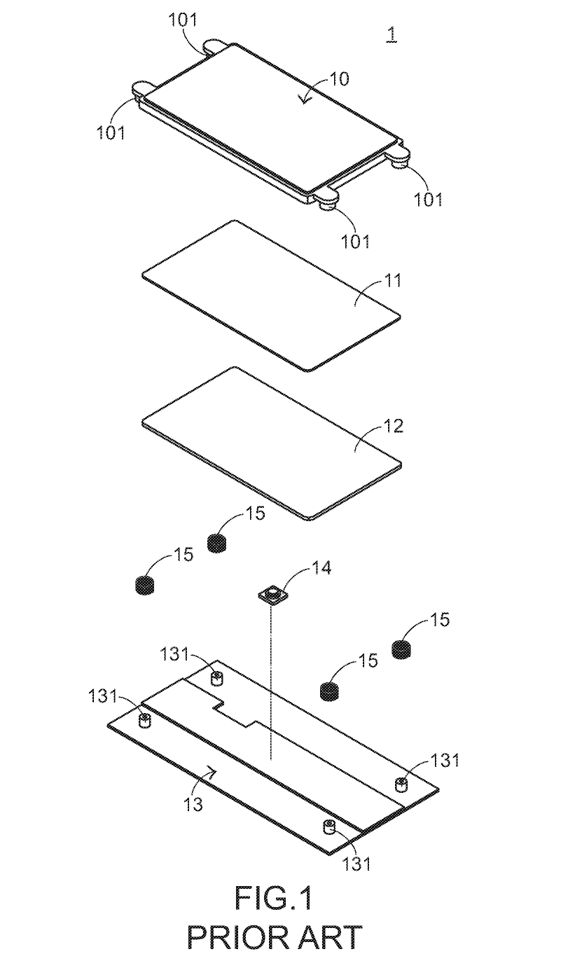

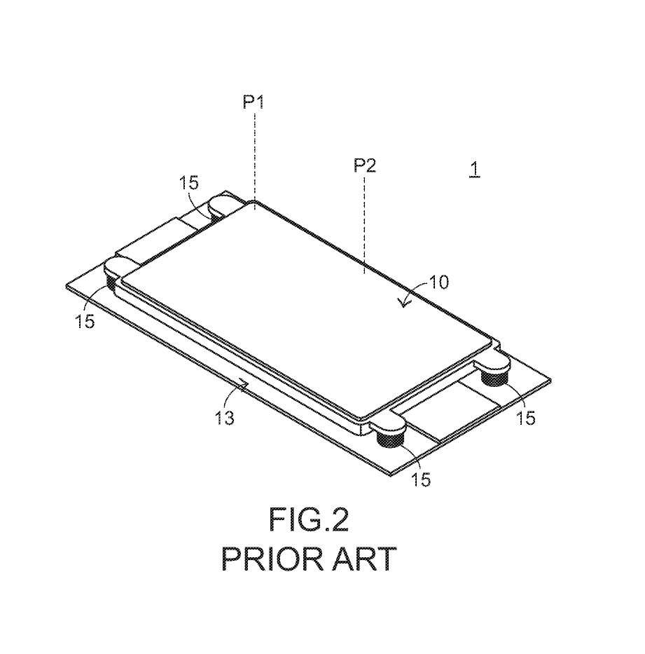

### DETAILED DESCRIPTION OF THE PREFERRED EMBODIMENT

For eliminating the drawbacks encountered from the prior art, the present invention provides a touch input device with a button function in order to provide an enhanced tactile feel.

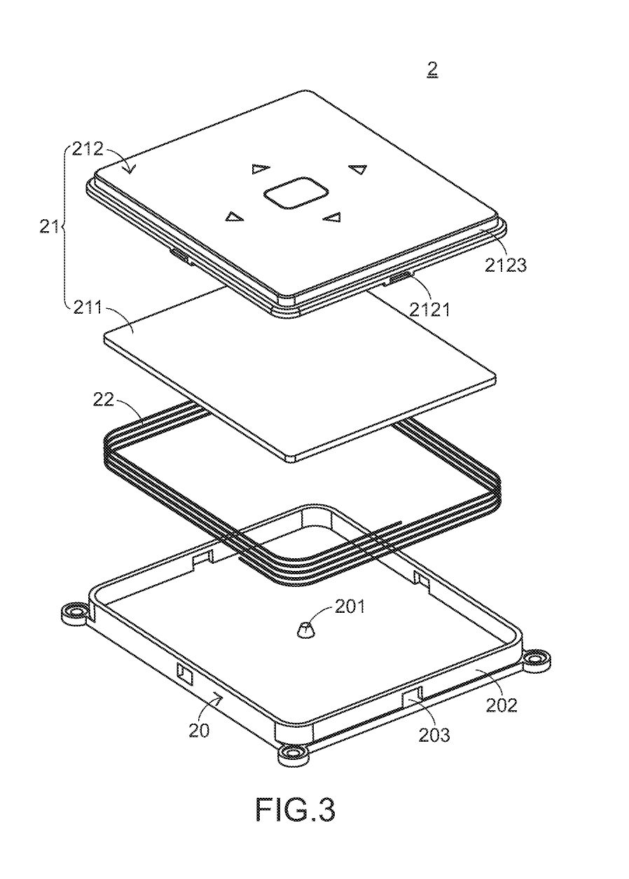

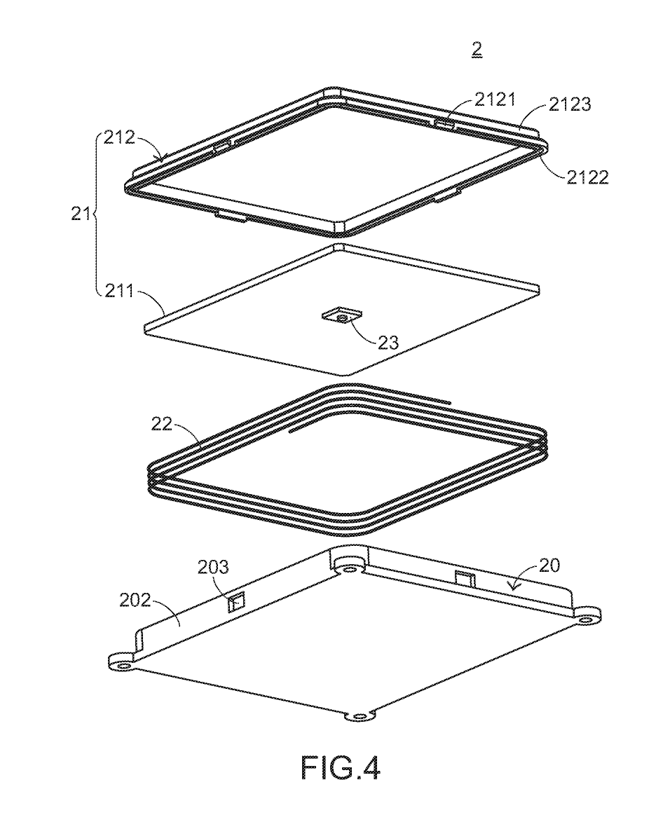

Hereinafter, the structure of a touch input device with a button function according to an embodiment of the present invention will be illustrated with reference to FIGS. 3 and 4. FIG. 3 is a schematic exploded view illustrating a touch input device with a button function according to an embodiment of the present invention. FIG. 4 is a schematic exploded view illustrating the touch input device of FIG. 3 and taken along another viewpoint. The touch input device 2 with the button function may be applied to a notebook computer or a remote controller of an electronic device. As shown in FIGS. 3 and 4, the touch input device 2 comprises a base plate 20, a touch module 21, an elastic element 22, and a triggering switch 23. The base plate 20 comprises a contact post 201, plural lateral walls 202, and at least one perforation 203. The contact post 201 is located at a middle region of the base plate 20. The plural lateral walls 202 are disposed around a peripheral area of the base pate 20. The at least one perforation 203 is formed in at least one lateral wall 202 of the base plate 20. In this embodiment, the contact post 201 is protruded upwardly from a surface of the base pate 20. Moreover, the plural lateral walls 202 are protruded from the peripheral area of the base pate 20. That is, the contact post 201 and the plural lateral walls 202 are integrally formed with the base pate 20. Moreover, the base pate 20 is made of a plastic material.

The elastic element 22 is disposed over the base pate 20 and under the touch module 21 for providing an elastic force to the touch module 21. The elastic element 22 is disposed around the peripheral area of the base pate 20. Moreover, a shape of the wound structure of the elastic element 22 matches the shape of the peripheral area of the base pate 20. In this embodiment, the elastic element 22 is a spiral spring, which is made of a metallic material. Moreover, since the peripheral area of the base pate 20 has a square shape, the elastic element 22 is wound as a square shape.

The touch module 21 is disposed over the base plate 20. When the touch module 21 is touched and a touched position of the touch module 21 is detected, the touch module 21 generates a touch signal. The touch module 21 comprises a touch sensitive plate 211 and a protective cover 212. The touch sensitive plate 211 is used for detecting the touched position, thereby generating the touch signal. The protective cover 212 is used for covering the touch sensitive plate 211 and contacting with the base plate 20 and the elastic element 22 in order to protect the touch sensitive plate 211. The protective cover 212 comprises at least one hooking structure 2121 and a fixing recess 2122. The at least one hooking structure 2121 is aligned with the at least one perforation 203 of the base plate 20, and formed on at least one lateral wall 2123 of the protective cover 212. The at least one hooking structure 2121 is inserted into the at least one perforation 203 of the base plate 20. Due to the engagement between the at least one hooking structure 2121 and the at least one perforation 203 of the base plate 20, the protective cover 212 is fixed on the base plate 20. The fixing recess 2122 is formed in the at least one lateral wall 2123 of the protective cover 212, and disposed over the peripheral area of the base plate 20. After the elastic element 22 is inserted into the fixing recess 2122, the elastic element 22 is fixed in the fixing recess 2122.

In this embodiment, an adhesive (not shown) is arranged between the touch sensitive plate 211 and the protective cover 212, so that the touch sensitive plate 211 and the protective cover 212 are connected with each other through the adhesive. The touch sensitive plate 211 is a capacitive touch sensitive plate. The at least one hooking structure 2121 and the fixing recess 2122 are integrally formed with the protective cover 212. Moreover, the protective cover 212 is made of a plastic material. The shape of the fixing recess 2122 matches the shape of the wound structure of the elastic element 22. That is, the fixing recess 2122 also has a square shape. Alternatively, in some other embodiments, the shape of the fixing recess and the shape of the wound structure of the elastic element may be square or circular.

The triggering switch 23 is disposed on the touch module 21. When the touch module 21 is depressed, the triggering switch 23 is triggered to generate a button signal corresponding to the touched position. In this embodiment, the triggering switch 23 is disposed on a bottom surface of the touch sensitive plate 211, and disposed over the contact post 201. In this embodiment, the triggering switch 23 is a mechanical micro switch. Moreover, the base plate 20 of the touch input device 2 further comprises an opening. For clarification and brevity, the opening is not shown in the drawings. The opening is formed in a bottom of the base plate 20. After a connecting wire (not shown) is penetrated through the opening, the connecting wire is electrically connected with the touch sensitive plate 211 in order to transmit electricity and signals.

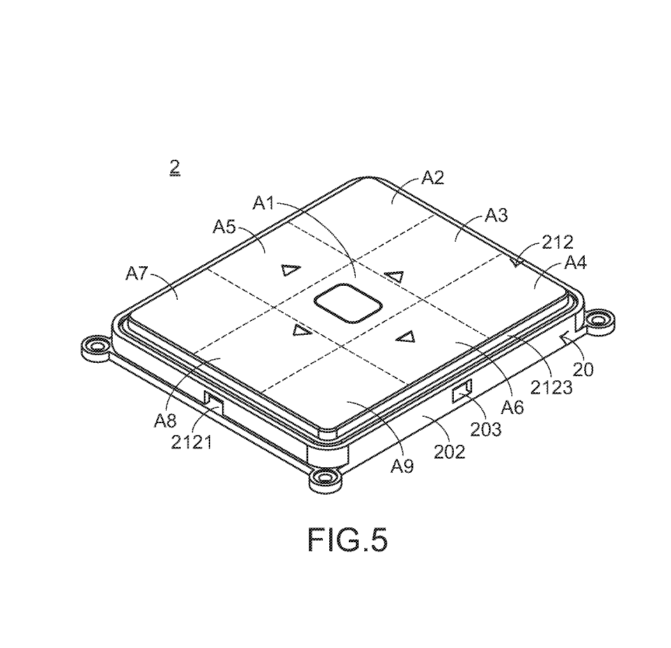

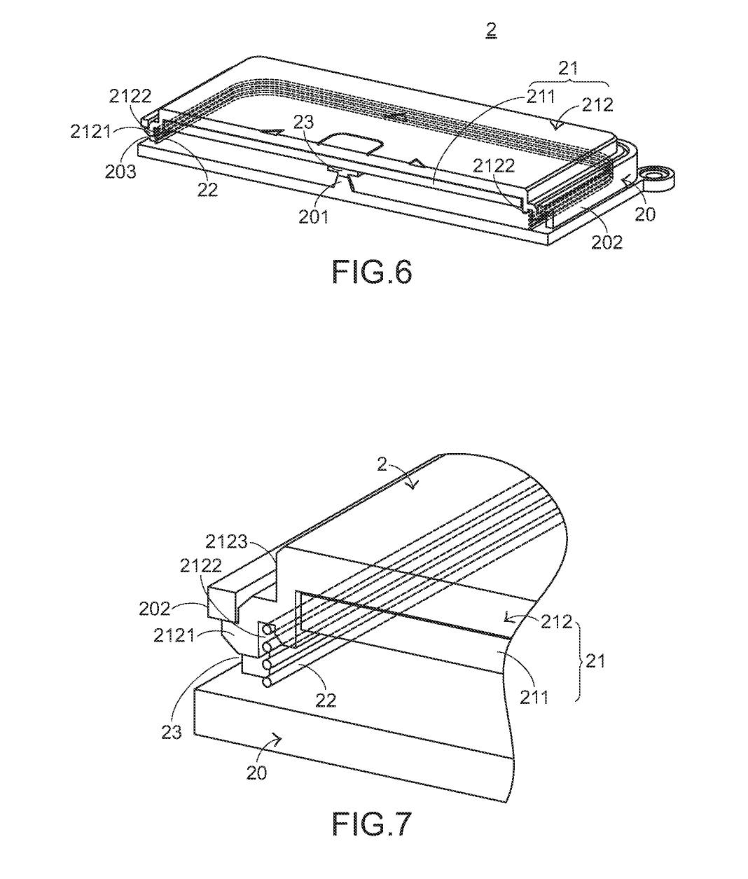

FIG. 5 is a schematic perspective view illustrating the outward appearance of the touch input device of FIG. 3. FIG. 6 is a schematic cutaway view illustrating the touch input device of FIG. 5. FIG. 7 is a schematic cutaway view illustrating a portion of the touch input device of FIG. 5. Please refer to FIGS. 6 and 7. After the base plate 20, the touch module 21, the elastic element 22 and the triggering switch 23 are combined together, the at least one hooking structure 2121 formed on the at least one lateral wall 2123 of the protective cover 212 is inserted into the corresponding perforation 203 of the base plate 20. Due to the engagement between the at least one hooking structure 2121 and the at least one perforation 203, the protective cover 212 is fixed on the base plate 20. On the other hand, since the elastic element 22 is disposed around the peripheral area of the base pate 20 and inserted into the fixing recess 2122 of the protective cover 212, the elastic element 22 is fixed in the space between the base plate 20 and the protective cover 212. Moreover, the triggering switch 23 is disposed on the bottom surface of the touch sensitive plate 211, and disposed over the contact post 201.

The operation of the touch input device with the button function according to the embodiment of the present invention will be illustrated as follows. As shown in FIG. 5, the protective cover 212 comprises nine regions, including a first region A1, a second region A2, a third region A3, a fourth region A4, a fifth region A5, a sixth region A6, a seventh region A7, an eighth region A8 and a ninth region A9. The first region A1 is located at a middle region of the protective cover 212. The second region A2, the third region A3, the fourth region A4, the fifth region A5, the sixth region A6, the seventh region A7, the eighth region A8 and the ninth region A9 are all disposed around the first region A1, and located at the peripheral area of the protective cover 212.

When the protective cover 212 of the touch module 21 is touched by the user and the user's finger (not shown) is moved on the protective cover 212, the cursor of the notebook computer or the electronic device (not shown) which is in communication with the touch input device of the present invention is correspondingly moved with the user's finger. Consequently, a corresponding command is executed.

Please refer to FIGS. 6 and 7 again. When the second region A2 of the protective cover 212 is depressed by the user's finger, the protective cover 212 is depressed and moved downwardly relative to the base plate 20. Consequently, the elastic element 22 is compressed by the protective cover 212 to accumulate an elastic force. On the other hand, since the touched position is detected by the touch sensitive plate 211 and the touch sensitive plate 211 is moved downwardly relative to the base plate 20, the contact post 201 is contacted with the triggering switch 23 to rigger the triggering switch 23. Under this circumstance, the button signal corresponding to the touched position (i.e. the second region A2) is outputted from the triggering switch 23 to the notebook computer or the electronic device. When the user's finger is departed from the protective cover 212 and the protective cover 212 is no longer depressed by the user's finger, the elastic force of the elastic element 22 is released. Under this circumstance, the protective cover 212 and the touch sensitive plate 211 are moved upwardly relative to the base plate 20 and returned to their original positions. In addition, the triggering switch 23 is no longer triggered. Meanwhile, the triggering switch 23 and the contact post 201 are not contacted with each other. Similarly, when the eighth region A8 of the protective cover 212 is depressed by the user's finger, the operations of the touch input device are similar to those mentioned above, and are not redundantly described herein.

Moreover, since the elastic element 22 is contacted with the fixing recess 2122 and the fixing recess 2122 is disposed around the peripheral area of the protective cover 212, the second region A2, the third region A3, the fourth region A4, the fifth region A5, the sixth region A6, the seventh region A7, the eighth region A8 and the ninth region A9 at the peripheral area of the protective cover 212 are substantially equidistant from the elastic element 22. Since these regions A2˜A9 at the peripheral area of the protective cover 212 have substantially identical level arms relative to the triggering switch 23, the magnitudes of the torques on these regions A2˜A9 are nearly identical. In other words, the elastic force received by each of these regions A2˜A9 is substantial equal. Furthermore, according to a special design, the elastic force received by the first region A1 at the middle region of the protective cover 212 is close to the elastic force received by each of these regions A2˜A9. Consequently, when each position of the protective cover 212 is depressed by the user, the elastic force received by each position of the protective cover 212 is substantial equal. Since the tactile feel on each position of the protective cover 212 is nearly identical for the user, the tactile feel is distributed more uniformly.

From the above descriptions, the present invention provides a touch input device with a button function. The touch input device of the present invention uses a single elastic element in replace of the plural elastic elements of the conventional touch input device. Moreover, the single elastic element is disposed around the base plate and the protective cover in order to provide the equal level arms at different positions of the protective cover. Consequently, when each position of the protective cover is depressed by the user, the elastic force received by each position of the protective cover is substantial equal. Since the tactile feel on each position of the protective cover is nearly identical for the user, the tactile feel is distributed more uniformly when compared with the conventional touch input device. Moreover, in the touch input device of the present invention, the elastic element is made of a metallic material, and the base plate and the protective cover are made of plastic materials. Since the touch input device of the present invention has less number of metallic components, the possibility of erroneously detecting the touch sensitive plate by the metallic components will be minimized.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch input device with a button function, said touch input device comprising:
a base plate;
a touch module disposed over said base plate, wherein when said touch module is touched and a touched position is detected by said touch module, said touch module generates a touch signal;
an elastic element disposed over said base plate and under said touch module for providing an elastic force to said touch module, wherein said elastic element is disposed around a peripheral area of said base pate; and
a triggering switch disposed on said touch module, wherein when said touch module is depressed, said triggering switch is triggered to generate a button signal corresponding to said touched position.

2. The touch input device according to claim 1, wherein said elastic element is a spiral spring, which is made of a metallic material, wherein a shape of a wound structure of said elastic element matches a shape of said peripheral area of said base pate.

3. The touch input device according to claim 1, wherein said touch module comprises:
a touch sensitive plate for detecting said touched position, thereby generating said touch signal;
a protective cover for covering said touch sensitive plate and contacting with said base plate and said elastic element, thereby protecting said touch sensitive plate.

4. The touch input device according to claim 3, wherein said protective cover comprises:
at least one hooking structure formed on at least one lateral wall of said protective cover, wherein when said at least one hooking structure is engaged with said base plate, said protective cover is fixed on said base plate; and
a fixing recess formed in said at least one lateral wall of said protective cover and disposed over said peripheral area of said base plate, wherein when said elastic element is inserted into said fixing recess, said elastic element is fixed in said fixing recess.

5. The touch input device according to claim 4, wherein said base plate comprises at least one perforation, which is aligned with said at least one hooking structure and formed in at least one lateral wall of said base plate, wherein when said at least one hooking structure is inserted into said at least one perforation, said at least one hooking structure is engaged with said at least one perforation.

6. The touch input device according to claim 5, wherein said at least one lateral wall of said base plate is protruded from said peripheral area of said base pate and integrally formed with said base plate, wherein said base pate is made of a plastic material.

7. The touch input device according to claim 4, wherein said at least one hooking structure and said fixing recess are integrally formed with said protective cover, and said protective cover is made of a plastic material, wherein a shape of said fixing recess matches a shape of a wound structure of said elastic element.

8. The touch input device according to claim 3, wherein said base plate further comprises a contact post, and said contact post is located at a middle region of said base plate, wherein said triggering switch is disposed on a bottom surface of said touch sensitive plate and disposed over said contact post.

9. The touch input device according to claim 8, wherein when said protective cover is depressed and moved downwardly relative to said base plate, said elastic element is compressed by said protective cover to accumulate said elastic force, said touched position is detected by said touch sensitive plate and said touch sensitive plate is moved downwardly relative to said base plate, so that said contact post is contacted with said triggering switch to trigger said triggering switch, wherein when said triggering switch is triggered, said button signal corresponding to said touched position is generated by said triggering switch, wherein when said protective cover is not depressed, said elastic force of said elastic element is released, so that protective cover and said touch sensitive plate are moved upwardly relative to said base plate and said triggering switch is not contacted with said contact post.

10. The touch input device according to claim 3, wherein said touch sensitive plate is a capacitive touch sensitive plate.
